(19) United States
(12) Patent Application Publication
(10) Pub. No.: US 2019/0171046 A1
(43) Pub. Date: Jun. 6, 2019

(54) LIQUID CRYSTAL DISPLAY DEVICE AND METHOD OF MANUFACTURING LIQUID CRYSTAL DISPLAY DEVICE

(71) Applicant: Mitsubishi Electric Corporation, Tokyo (JP)

(72) Inventor: Yuto SHIMOWADA, Kumamoto (JP)

(73) Assignee: Mitsubishi Electric Corporation, Tokyo (JP)

(21) Appl. No.: 16/190,198

(22) Filed: Nov. 14, 2018

(30) Foreign Application Priority Data
Dec. 4, 2017 (JP) 2017-232389

(51) Int. Cl. G02F 1/13; G02F 1/1335; G02F 1/13357; G02F 1/1333

(52) U.S. Cl. CPC G02F 1/1309; G02F 1/133528; G02F 1/1336; G02F 1/133308; G02F 2001/133314; G02F 2001/133531; G02F 2001/133325; G02F 2001/133331; G02F 2202/28

(57) ABSTRACT

An object of the present invention is to provide a technique in a liquid crystal display device capable of performing rework processing easily, suppressing an increase in a manufacturing cost and size of the liquid crystal display device, and increasing reliability. The liquid crystal display device includes a liquid crystal panel, a backlight, the front surface polarization plate, and a back surface polarization plate. Each of a first bonding layer and a second bonding layer is any of an uncured bonding layer having a property that an adhesion property capable of fixing the front surface polarization plate and the back surface polarization plate to the liquid crystal panel can be obtained through curing processing and a semi-cured bonding layer having a property of being softened through softening processing.

### FIELD OF THE INVENTION

The present invention relates to a liquid crystal display device and a method of manufacturing the liquid crystal display device.

### DESCRIPTION OF THE BACKGROUND ART

A liquid crystal display device generally has a structure that an array substrate, which includes a thin film transistor (TFT) and a pixel electrode (referred to as the “TFT array substrate” hereinafter), and a counter substrate, which includes a color filter for performing a color display (referred to as the “CF substrate” hereinafter), are bonded to each other as one pair, a polarization plate is further bonded to both surfaces thereof for a purpose of polarization control, and furthermore, a protection plate is put on a front surface and a backlight is put on a back surface.

A foreign material enters between a liquid crystal panel and a polarization plate at a time of bonding the polarization plate in a manufacturing process of the liquid crystal display device, thereby being visually recognized as a panel defect in some cases. In that case, rework processing of separating the polarization plate and bonding it again may be implemented.

However, in accordance with a recent reduced thickness in the liquid crystal panel and the polarization plate and a glass plate such as the TFT array substrate and the CF substrate, which are constituent members of the liquid crystal panel, a breaking of the glass substrate and a residue of the polarization plate after the separation increasingly occur in the rework processing, and affect the manufacture of the liquid crystal display device. There is also a case where a gap between the TFT array substrate and the CF substrate changes due to a large stress on the liquid crystal panel in the rework processing, thereby causing a gap unevenness deteriorating a display quality.

In the meanwhile, necessity of a curved surface display recently increases in terms of designability and space saving. In this curved surface display, the thickness of the glass substrate is greatly reduced to curve the liquid crystal panel. Thus, an extremely thin glass substrate whose thickness is remarkably reduced to approximately 0.2 mm or less in thin glass substrates is used. If a panel figuration in which the polarization plate is bonded to the extremely thin glass substrate is adopted, the rework processing is realistically difficult.

In order to counter such a problem, Japanese Patent Application Laid-Open No. 2010-2487 proposes a structure that polarization plates are bonded to protection plates disposed in a front surface and a back surface to perform the rework processing easily.

Japanese Patent Application Laid-Open No. 2009-192838 proposes a structure that a bonding layer of a polarization plate is provided only outside a display surface or a substrate surface of a liquid crystal panel.

### SUMMARY

However, in the structure described in Japanese Patent Application Laid-Open No. 2010-2487, the protection plates need to be disposed on the front surface and the back surface, and such a structure is not preferable in that it causes an increase in a manufacturing cost of the liquid crystal display device and a weight and a thickness of the liquid crystal display device increase.

In the structure described in Japanese Patent Application Laid-Open No. 2009-192838, there is a concern for a reduction in reliability of the liquid crystal display device due to a bonding strength poverty between the polarization plate and the liquid crystal panel.

An object of the present invention is to provide a technique in a liquid crystal display device capable of performing rework processing easily, suppressing an increase in a manufacturing cost and size of the liquid crystal display device, and increasing reliability.

A liquid crystal display device according to the present invention includes a liquid crystal panel, a backlight, a front surface polarization plate, and a back surface polarization plate. The liquid crystal panel has a pair of glass substrates being disposed opposite to each other via a liquid crystal layer. The backlight is disposed on a back surface side of the liquid crystal panel. The front surface polarization plate is disposed on a front surface of the liquid crystal panel via a first bonding layer. The back surface polarization plate is disposed on a back surface of the liquid crystal panel via a second bonding layer between the liquid crystal panel and the backlight. Each of the first bonding layer and the second bonding layer is any of an uncured bonding layer having a property that an adhesion property capable of fixing the front surface polarization plate and the back surface polarization plate to the liquid crystal panel can be obtained through curing processing and a semi-cured bonding layer having a property of being softened through softening processing.

If the first bonding layer and the second bonding layer are the uncured bonding layers, the first bonding layer and the second bonding layer do not obtain an adhesion property capable of fixing the front surface polarization plate and the back surface polarization plate to the liquid crystal panel before curing processing is performed. if the first bonding layer and the second bonding layer are semi-cured bonding layers, the first bonding layer and the second bonding layer are softened through softening processing. Accordingly, rework processing can be performed easily.

A protection plate needs not be disposed on the back surface side of the liquid crystal panel, thus an increase in a manufacturing cost and size of the liquid crystal display device can be suppressed. Even if the first bonding layer and the second bonding layer are disposed on the entire front surface and back surface of the liquid crystal panel, they do not influence the rework processing, thus the first bonding layer and the second bonding layer can be disposed on the entire front surface and back surface of the liquid crystal panel, and a bonding strength necessary to fix the front surface polarization plate and the back surface polarization plate to the liquid crystal panel can be maintained. Accordingly, reliability of the liquid crystal display device can be increased.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view of a liquid crystal display device according to an embodiment 1.

FIG. 2 is a cross sectional view showing a manufacturing process of the liquid crystal display device according to the embodiment 1.

FIG. 3 is a cross sectional view showing the manufacturing process of the liquid crystal display device according to the embodiment 1.

FIG. 4 is a cross sectional view showing the manufacturing process of the liquid crystal display device according to the embodiment 1.

FIG. 5 is a cross sectional view showing the manufacturing process of the liquid crystal display device according to the embodiment 1.

FIG. 6 is a cross sectional view of a liquid crystal display device according to an embodiment 2.

FIG. 7 is a cross sectional view of another example of the liquid crystal display device according to the embodiment 2.

FIG. 8 is a cross sectional view showing the manufacturing process of the liquid crystal display device according to the embodiment 2.

FIG. 9 is an explanation diagram for describing a method of adjusting an optical axis of the liquid crystal display device according to the embodiment 2.

FIG. 10 is a cross sectional view showing the manufacturing process of the liquid crystal display device according to the embodiment 2.

FIG. 11 is a cross sectional view of a liquid crystal display device according to a modification example of the embodiment 2.

FIG. 12 is a cross sectional view of a liquid crystal display device according to an embodiment 3.

FIG. 13 is a cross sectional view of another example of the liquid crystal display device according to the embodiment 3.

FIG. 14 is a cross sectional view of a liquid crystal display device according to an embodiment 4.

FIG. 15 is an explanation diagram for describing a retention form of each polarization plate of the liquid crystal display device according to the embodiment 4.

### DESCRIPTION OF THE PREFERRED EMBODIMENTS

### Embodiment 1

The embodiment 1 of the present invention is described hereinafter using the drawings. Each of a liquid crystal display device according to the embodiment 1 and a method of manufacturing the same is described here. Firstly, a configuration of the liquid crystal display device according to the embodiment 1 is described using FIG. 1. FIG. 1 is a cross sectional view of the liquid crystal display device according to the embodiment 1.

As shown in FIG. 1, the liquid crystal display device includes a transparent protection plate 1, a front surface polarization plate 2, a liquid crystal panel 3, a back surface polarization plate 7, and a backlight 8.

A liquid crystal panel 3 includes a CF substrate 4, a liquid crystal layer 5, and a TFT array substrate 6. Each of the CF substrate 4 and the TFT array substrate 6 is a thin glass substrate, and is made up of a glass substrate processed to have a reduced thickness of approximately 0.3 mm, which is a general thickness as the thin glass substrate. The CF substrate 4 and the TFT array substrate 6 are also simply referred to as the thin glass substrates 4 and 6 in some cases hereinafter. A pair of the thin glass substrates 4 and 6 are disposed opposite to each other with the liquid crystal layer 5 therebetween. A sealing member 5a sealing the liquid crystal layer 5 is disposed over an outer periphery of the liquid crystal layer 5.

The front surface polarization plate 2 is disposed on a front surface of the liquid crystal panel 3 with a first bonding layer 10 therebetween and is fixed. The back surface polarization plate 7 is disposed on a back surface of the liquid crystal panel 3 with a second bonding layer 11 therebetween and is fixed. The front surface polarization plate 2 and the back surface polarization plate 7 are thus disposed opposite to the thin glass substrates 4 and 6, which constitute the liquid crystal panel 3, respectively. Each of the first bonding layer 10 and the second bonding layer 11 is an uncured bonding layer having a property that an adhesion property capable of fixing the front surface polarization plate 2 and the back surface polarization plate 7 to the liquid crystal panel 3 is obtained through curing processing. Herein, a photo-curing bonding agent having a property of being cured through photo-curing processing is used as an uncured bonding agent forming the uncured bonding layer, for example.

The uncured bonding agent is not limited to the photo-curing bonding agent described above, however, a thermoset resin or a thermoset bonding agent having a property of being cured through thermal curing processing may also be used, and alternatively, it is also applicable to use a bonding agent having a property of being cured through drying processing for a predetermined period of time to obtain the adhesion property described above.

As shown in FIG. 1 in the liquid crystal display device according to the embodiment 1, the transparent protection plate 1 made up of a glass plate or a plastic plate is disposed on a front surface side of the liquid crystal panel 3 for a purpose of protecting the liquid crystal panel 3. The transparent protection plate 1 is fixed to the front surface polarization plate 2 with a transparent adhesive layer 9 therebetween. Accordingly, the liquid crystal panel 3 can be protected without an influence on visibility of the liquid crystal panel 3. A touch panel function may be added to the transparent protection plate 1, for example. The backlight 8 is disposed on a back surface side of the liquid crystal panel 3.

### (A Method of Manufacturing a Liquid Crystal Display Device)

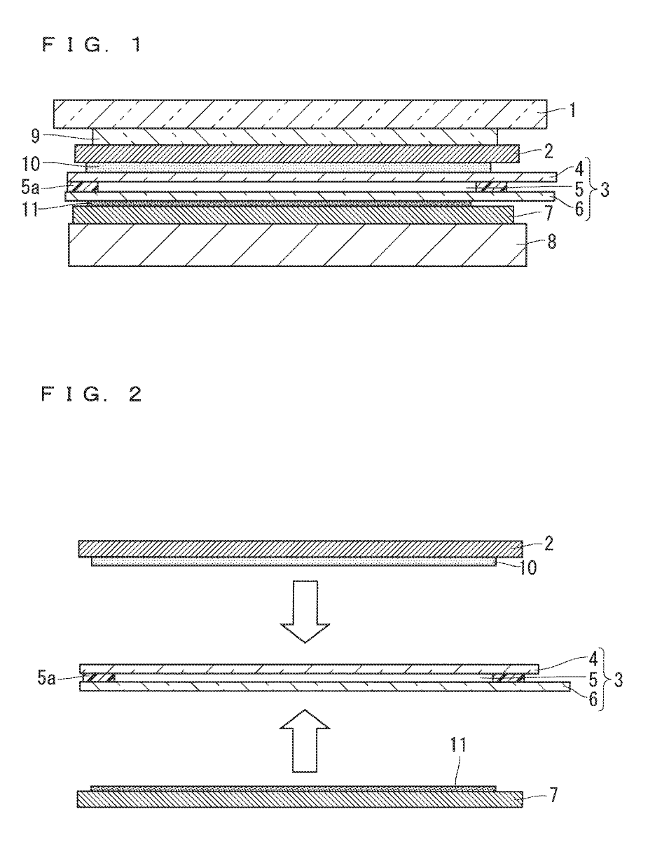

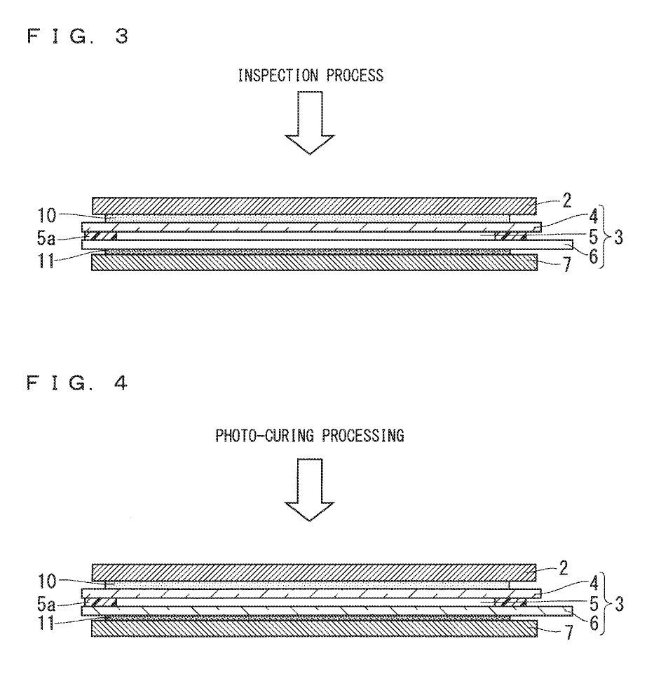

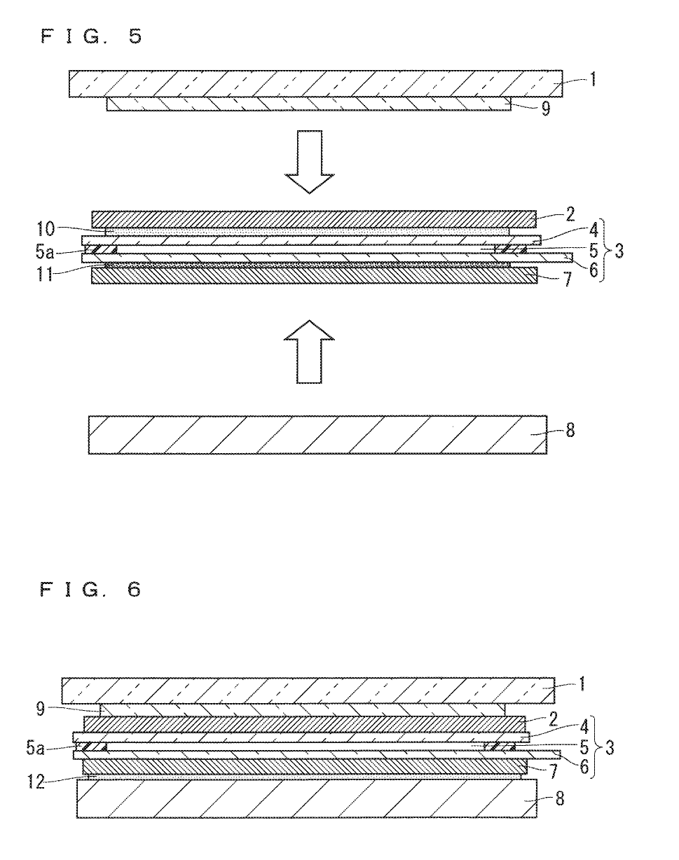

Subsequently, a method of manufacturing the liquid crystal display device according to the embodiment 1 is described using FIG. 2 to FIG. 5. FIG. 2 is a cross sectional view showing the manufacturing process of the liquid crystal display device, and more specifically, a cross sectional view showing a temporal fixation process. FIG. 3 is a cross sectional view showing the manufacturing process of the liquid crystal display device, and more specifically, a cross sectional view showing an inspection process. FIG. 4 is a cross sectional view showing the manufacturing process of the liquid crystal display device, and more specifically, a cross sectional view showing a process of optical processing. FIG. 5 is a cross sectional view showing the manufacturing process of the liquid crystal display device, and more specifically, a cross sectional view showing a process of fixing the transparent protection plate 1 and the backlight 8.

A characteristic part of the method of manufacturing the liquid crystal display device according to the embodiment 1 is described hereinafter, and a description of a part in common with a method of manufacturing a conventional liquid crystal display device is appropriately omitted.

Firstly, as shown in FIG. 2, the front surface polarization plate 2 on which the first bonding layer 10 is formed and the back surface polarization plate 7 on which the second bonding layer 11 is formed are bonded to the front surface and the back surface of the liquid crystal panel 3 from the front surface side and the back surface side, respectively. Each of the first bonding layer 10 and the second bonding layer 11 is formed of a photo-curing bonding agent.

Herein, the photo-curing bonding agent is bonded in an uncured state. That is to say, the front surface polarization plate 2 and the back surface polarization plate 7 are in a temporal fixation state immediately after the temporal fixation process. The temporal fixation state indicates a state where the front surface polarization plate 2 and the back surface polarization plate 7 can be easily separated from the liquid crystal panel 3.

Subsequently, as shown in FIG. 3, the inspection process is performed on the liquid crystal panel 3, on which the front surface polarization plate 2 and the back surface polarization plate 7 are fixed in the temporal fixation state, to confirm whether or not a foreign material or the like enters mainly between the front surface polarization plate 2 and the thin glass substrate 4 and between the back surface polarization plate 7 and the thin glass substrate 6 and confirm whether or not the rework processing needs to be performed on the front surface polarization plate 2 and the back surface polarization plate 7. Herein, the rework processing is made up of separation processing and re-bonding processing of separating and re-bonding the front surface polarization plate 2 from and to the back surface polarization plate 7.

The rework processing is performed on the liquid crystal panel 3 on which the rework processing needs to be performed in accordance with the determination made in the inspection process. Since the front surface polarization plate 2 and the back surface polarization plate 7 are temporarily fixed to the thin glass substrates 4 and 6, respectively, the rework processing can be comparatively easily performed without damaging the thin glass substrates 4 and 6. The inspection process is performed again on the thin glass substrates 4 and 6 on which the rework processing has been completed to determine whether or not the rework processing needs to be performed again.

In the meanwhile, in the liquid crystal panel 3 on which the rework processing needs not be performed in accordance with the determination made in the inspection process, the photo-curing processing is performed on the first bonding layer 10 and the second bonding layer 11 which are still uncured as shown in FIG. 4. Accordingly, the first bonding layer 10 and the second bonding layer 11 are cured to make the adhesion property of the bonding layers function effectively, thus the front surface polarization plate 2 and the back surface polarization plate 7 are fixed to the thin glass substrates 4 and 6.

Subsequently, as shown in FIG. 5, the transparent protection plate 1 is disposed on the liquid crystal panel 3 with the transparent adhesive layer 9 therebetween from the front surface side of the liquid crystal panel 3, and the backlight 8 is disposed on the liquid crystal panel 3 from the back surface side of the liquid crystal panel 3, thus the liquid crystal display device is completed. The transparent protection plate 1 is fixed to the liquid crystal panel 3 on the front surface side with the transparent adhesive layer 9 therebetween.

### (Effect)

As described above, in the liquid crystal display device according to the embodiment 1, the first bonding layer 10 and the second bonding layer 11 are the uncured bonding layers, thus the first bonding layer 10 and the second bonding layer 11 are not cured before the curing processing. Accordingly, the rework processing can be performed easily.

The protection plate needs not be disposed on the back surface side of the liquid crystal panel 3, thus an increase in a manufacturing cost and size of the liquid crystal display device can be suppressed. Even if the first bonding layer 10 and the second bonding layer 11 are disposed on the entire front surface and back surface of the liquid crystal panel 3, they do not influence the rework processing, thus the first bonding layer 10 and the second bonding layer 11 can be disposed on the entire front surface and back surface of the liquid crystal panel 3, and a bonding strength required between the front surface polarization plate 2 and the liquid crystal panel 3 and between the back surface polarization plate 7 and the liquid crystal panel 3 can be maintained. Accordingly, the reliability of the liquid crystal display device can be increased. According to the above configuration, a yield of the liquid crystal display device can be increased.

Since the liquid crystal panel 3 is temporarily fixed, the rework processing can be performed on the front surface polarization plate 2 and the back surface polarization plate 7 even if the thin glass substrates 4 and 6 are used in the liquid crystal panel 3, and the front surface polarization plate 2 and the back surface polarization plate 7 are fixed in the state where the liquid crystal panel 3 is configured in a conventional manner, thus a process subsequent to the fixing process of the front surface polarization plate 2 and the back surface polarization plate 7 can be achieved by a conventional manufacturing process, and an inspection can be performed in the state where the front surface polarization plate 2 and the back surface polarization plate 7 are fixed. Inconvenience in display such as a surface reflectivity does not occur. Furthermore, the front surface polarization plate 2 and the back surface polarization plate 7 are firmly fixed to the thin glass substrates 4 and 6, respectively, in the state where the liquid crystal display device is completed, thus a misalignment caused by vibration and the other factor does not occur, but both an effect of obtaining high reliability and an effect of reducing a cost achieved by performing the rework processing can be obtained.

The uncured bonding layer has the property that the uncured bonding layer is cured through the thermal curing processing, the photo-curing processing, or the drying processing and the adhesion property capable of fixing the front surface polarization plate 2 and the back surface polarization plate 7 to the liquid crystal panel 3 is thereby obtained. Accordingly, the various types of processing can be adopted, thus the liquid crystal display device can be easily manufactured. Since the transparent protection plate 1 is fixed to the front surface polarization plate 2 with the transparent adhesive layer 9 therebetween, the liquid crystal panel 3 can be protected without the influence on the visibility of the liquid crystal panel 3.

### Modification Example of Embodiment 1

Subsequently, a liquid crystal display device according to a modification example of the embodiment 1 is described. Changed in the liquid crystal display device according to the modification example of the embodiment 1 is that a semi-cured bonding layer having a property of being softened through softening processing is used as the first bonding layer 10 and the second bonding layer 11.

Examples of a semi-cured bonding agent forming the semi-cured bonding layer include, in the present modification example, a bonding agent made up of one of a bonding agent having a property of being softened through thermal processing (a so-called hot-melt resin) and a light-softened resin having a property of being softened through light irradiation processing.

### (A Method of Manufacturing a Liquid Crystal Display Device)

Subsequently, a method of manufacturing the liquid crystal display device according to the modification example of the embodiment 1 is described hereinafter. A part of the method of manufacturing the liquid crystal display device changed from that according to the embodiment 1, which has been described already, is mainly described, and a description of a conventional method of manufacturing the liquid crystal display device or a part in common with the method of manufacturing the liquid crystal display device according to the embodiment 1 is appropriately omitted.

Firstly, in the manner similar to the method of manufacturing the liquid crystal display device according to the embodiment 1, the front surface polarization plate 2 on which the first bonding layer 10 is formed and the back surface polarization plate 7 on which the second bonding layer 11 is formed are bonded to the front surface and the back surface of the liquid crystal panel 3 from the sides of the front surface and the back surface, respectively. Each of the first bonding layer 10 and the second bonding layer 11 is formed of a semi-cured bonding agent

Herein, the semi-cured bonding agent is bonded in a state where the softening processing is not yet performed. That is to say, immediately after the temporal fixation process, the front surface polarization plate 2 and the back surface polarization plate 7 are fixed with the large adhesion property in some degree compared to the temporal fixation state in the case of the embodiment 1.

Subsequently, the inspection process is performed on the liquid crystal panel 3, on which the front surface polarization plate 2 and the back surface polarization plate 7 are fixed in the temporal fixation state, to confirm whether or not a foreign material or the like enters mainly between the front surface polarization plate 2 and the thin glass substrate 4 and between the back surface polarization plate 7 and the thin glass substrate 6 and confirm whether or not the rework processing needs to be performed on the front surface polarization plate 2 and the back surface polarization plate 7.

The rework processing is performed on the liquid crystal panel 3 on which the rework processing needs to be performed in accordance with the determination made in the inspection process. In the present modification example, differing from the case of the embodiment 1, the front surface polarization plate 2 and the back surface polarization plate 7 are fixed to the thin glass substrates 4 and 6 via the first bonding layer 10 and the second bonding layer 11 with the large adhesion property in some degree, so that it is hard to perform the rework processing at that rate. Thus, the softening processing is performed on the first bonding layer 10 and the second bonding layer 11 so that they are softened enough to separate the front surface polarization plate 2 and the back surface polarization plate 7 easily.

Specifically, if the semi-cured bonding agent forming the first bonding layer 10 and the second bonding layer 11 is made up of the hot-melt resin, for example, the thermal processing needs to be performed, and if it is made up of the light-softened resin, the light irradiation processing needs to be performed. As described above, since the softening processing is performed on the first bonding layer 10 and the second bonding layer 11, the front surface polarization plate 2 and the back surface polarization plate 7 can be separated easily in the subsequent process, thus the rework processing can be performed comparatively easily without damaging the thin glass substrates 4 and 6. The inspection process is performed again on the substrate on which the rework processing has been completed through the process described above to determine whether or not the rework processing needs to be performed again.

In the meanwhile, in the liquid crystal panel 3 on which the rework processing needs not be performed in accordance with the determination made in the inspection process, if adhesion strength of the semi-cured bonding agent forming the first bonding layer 10 and the second bonding layer 11 is large enough to proceed with the subsequent manufacturing process or maintain the reliability of a product, the liquid crystal display device may be manufactured by placing the transparent protection plate 1 on the liquid crystal panel 3 via the transparent adhesive layer 9 from the front surface side of the liquid crystal panel 3 and placing the backlight 8 on the liquid crystal panel 3 from the back surface side of the liquid crystal panel 3 in the manner similar to the case of the embodiment 1. it is also applicable to proceed with the subsequent manufacturing process after appropriately performing main curing processing to further curing the semi-cured bonding agent in accordance with the adhesion strength of the semi-cured bonding agent or a degree of the curing of the semi-cured bonding agent.

### (Effect)

As described above, the effect similar to that in the case of the embodiment 1 can be obtained in the liquid crystal display device according to the modification example of the embodiment 1. Furthermore, the curing processing such as the photo-curing processing needs not be performed on the liquid crystal panel 3, on which the rework processing needs not be performed in accordance with the determination, which accounts for a large ratio of the manufactured liquid crystal panels 3, and the subsequent manufacturing process can be performed, thus the manufacturing cost of the liquid crystal display device can be further reduced.

Described in the embodiment 1 and the modification example described above is the liquid crystal display device applied to the configuration that the transparent protection plate 1 is disposed on the front surface side of the liquid crystal panel 3 via the transparent adhesive layer 9, however, the liquid crystal display device may also be applied to the configuration that the transparent protection plate 1 is not disposed. Also in that case, the front surface polarization plate 2 is firmly fixed to the thin glass substrates 4 in the state where the liquid crystal display device is completed, thus the misalignment caused by the vibration and the other factor does not occur, but both the effect of reducing the cost achieved by performing the rework processing and the effect of obtaining the high reliability can be obtained.

### Embodiment 2

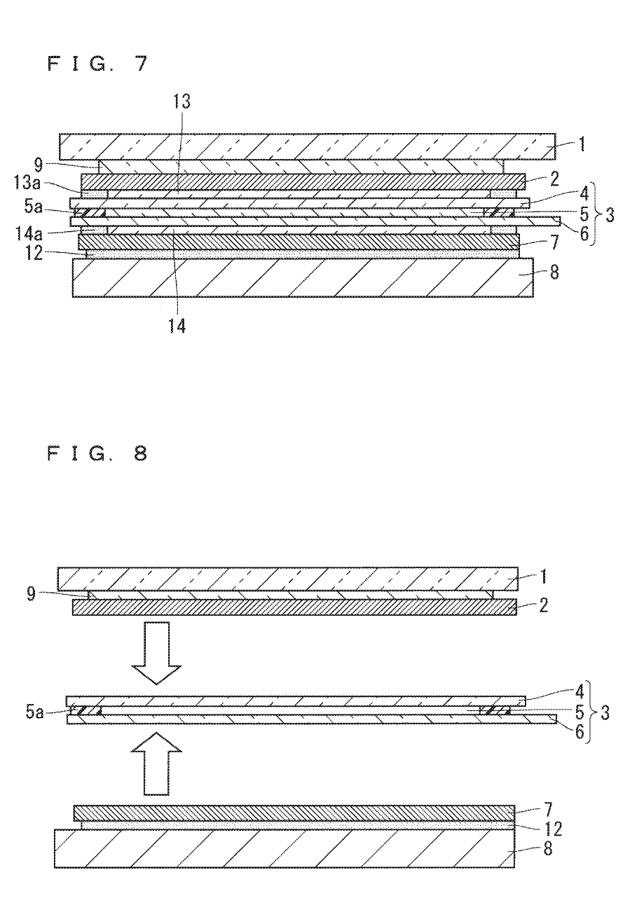

Next, a liquid crystal display device according to the embodiment 2 is described. FIG. 6 is a cross sectional view of the liquid crystal display device according to the embodiment 2. FIG. 7 is a cross sectional view of another example of the liquid crystal display device according to the embodiment 2. In the embodiment 2, the same reference numerals as those described in the embodiment 1 will be assigned to the same constituent element and the description thereof will be omitted.

As shown in FIG. 6 and FIG. 7, the liquid crystal display device according to the embodiment 2 is common to the liquid crystal display device according to the embodiment 1 in that the pair of the thin glass substrates 4 and 6 are disposed opposite to each other with the liquid crystal layer 5 therebetween, and furthermore, the front surface polarization plate 2 and the back surface polarization plate 7 are disposed opposite to the thin glass substrates 4 and 6, which constitute the liquid crystal panel 3, respectively. However, a constituent element to which the front surface polarization plate 2 and the back surface polarization plate 7 are fixed is different. Specifically, the front surface polarization plate 2 is fixed to the transparent protection plate 1 disposed opposite to the front surface side of the liquid crystal panel 3 with the transparent adhesive layer 9 therebetween. The back surface polarization plate 7 is fixed to the backlight 8 disposed opposite to the back surface side of the liquid crystal panel 3 with a third bonding layer 12 therebetween.

In the meanwhile, also applicable as a configuration between the front surface polarization plate 2 and the liquid crystal panel 3 and between the back surface polarization plate 7 and the liquid crystal panel 3 is a configuration that the polarization plates 2 and 7 are disposed opposite to the thin glass substrates 4 and 6 to be in close contact with the thin glass substrates 4 and 6, respectively, with no constituent element therebetween as shown in FIG. 6. Also applicable is a configuration that the front surface polarization plate 2 and the back surface polarization plate 7 are disposed opposite to each other with refraction index adjustment layers 13 and 14 between the front surface polarization plate 2 and the thin glass substrate 4 and between the back surface polarization plate 7 and the thin glass substrate 6 as shown in FIG. 7. Herein, each of the refraction index adjustment layers 13 and 14 is a fluent resin layer having substantially the same refraction index as that of glass. Each of the refraction index adjustment layers 13 and 14 may be a low-viscosity transparent bonding agent, for example.

FIG. 7 illustrates a case of providing bonding layers 13a and 14a each having a frame-like shape on an assumption of a function of sealing the refraction index adjustment layers 13 and 14 in a predetermined region in a case where viscosity of the refraction index adjustment layers 13 and 14 is particularly small and a function of fixing the polarization plates 2 and 7 to the thin glass substrates 4 and 6 at peripheral portions with a small temporal fixation degree, respectively. The bonding layers 13a and 14a need not have the frame-like shape if only the latter function is assumed, thus the bonding layers 13a and 14a may be locally disposed in a dot form on a corner of the liquid crystal panel 3, for example.

In any of the structures shown in FIG. 6 and FIG. 7 and the other illustrated structure, the polarization plates 2 and 7 and the thin glass substrates 4 and 6 are fixed to each other, respectively, with the adhesion strength smaller than that between the thin glass substrates 4 and 6. Thus, achieved is the configuration that the polarization plates 2 and 7 and the thin glass substrates 4 and 6 are not fixed to each other, respectively, or the front surface polarization plate 2 and the back surface polarization plate 7 are disposed opposite to each other with the adhesion strength allowing the front surface polarization plate 2 and the back surface polarization plate 7 to separate easily from the thin glass substrates 4 and 6, respectively.

The structures in FIG. 6 and FIG. 7 do not clearly show a configuration of fixing the transparent protection plate 1 to which the front surface polarization plate 2 is fixed and the backlight 8 to which the back surface polarization plate 7 is fixed between the transparent protection plate 1 and the backlight 8. However, if the polarization plates 2 and 7 and the thin glass substrates 4 and 6 are not fixed to each other, respectively, a misalignment occurs therebetween. Thus, in case of adopting the configuration that the adhesion strength between the polarization plates 2 and 7 and the thin glass substrates 4 and 6 is not large enough to keep adhesion therebetween, it is preferable to separately provide a configuration of fixing the transparent protection plate 1 and the backlight 8 to each other between the transparent protection plate 1 and the backlight 8.

In fixing the back surface polarization plate 7 to the backlight 8, the backlight 8 has a configuration that a housing constituting the backlight 8 is not provided in a path of irradiation light from a light source housed in the backlight 8 toward the liquid crystal panel 3 but an opening is provided, and a surface of the backlight 8 disposed opposite to the liquid crystal panel 3 is provided on a periphery of the opening, thus the backlight 8 substantially has only a frame-like surface. Thus, the third bonding layer 12 fixing the back surface polarization plate 7 to the backlight 8 corresponds to the frame-like surface of the backlight 8 and has a frame-like shape.

### (A Manufacturing Method A of the Liquid Crystal Display Device)

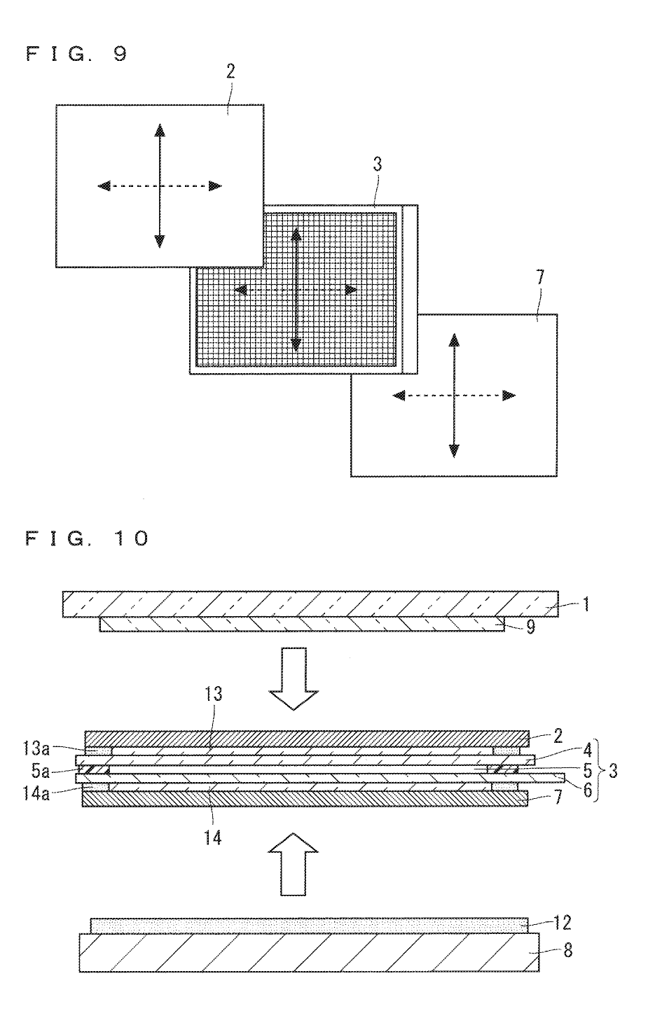

Subsequently, a method of manufacturing the liquid crystal display device according to the embodiment 2 is described hereinafter. As the method of manufacturing the liquid crystal display device according to the embodiment 2, a manufacturing method A described using FIG. 8 and FIG. 9 and a manufacturing method B described using FIG. 10 can be mainly adopted. The manufacturing method A is described firstly. FIG. 8 is a cross sectional view showing a manufacturing process of the liquid crystal display device according to the embodiment 2. FIG. 9 is an explanation diagram for describing a method of adjusting an optical axis of the liquid crystal display device according to the embodiment 2.

In the manufacturing method A, as shown in FIG. 8, a process of fixing the polarization plates 2 and 7 to the transparent protection plate 1 and the backlight 8, respectively, is performed, and subsequently, a process of placing the polarization plates 2 and 7 and the members fixed to the polarization plates 2 and 7 (that is to say, the transparent protection plate 1 and the backlight 8) opposite to the thin glass substrates 4 and 6, which constitute the liquid crystal panel 3, is performed. If the liquid crystal display device according to the embodiment in FIG. 7 is manufactured, the process of placing the polarization plates 2 and 7 and the members fixed to the polarization plates 2 and 7 opposite to the thin glass substrates 4 and 6, which constitute the liquid crystal panel 3, is performed after performing a process of forming the refraction index adjustment layers 13 and 14 and the frame-like bonding layers 13a and 14a on the polarization plates 2 and 7.

Subsequently, in the manner similar to the manufacturing method in the embodiment 1, the inspection process is performed to appropriately confirm whether or not a foreign material or the like enters between the front surface polarization plate 2 and the thin glass substrate 4 and between the hack surface polarization plate 7 and the thin glass substrate 6 in the state where the polarization plates 2 and 7 are disposed opposite to the thin glass substrates 4 and 6, respectively, and confirm whether or not the rework processing needs to be performed on the polarization plates 2 and 7 disposed opposite to the thin glass substrates 4 and 6.

The rework processing is performed on the liquid crystal panel 3 on which the rework processing needs to be performed in accordance with the determination made in the inspection process. Since the front surface polarization plate 2 and the back surface polarization plate 7 are disposed opposite to the thin glass substrates 4 and 6, respectively, in a state where the front surface polarization plate 2 and the back surface polarization plate 7 can be separated from the thin glass substrates 4 and 6 easily, the rework processing can be comparatively easily performed without damaging the thin glass substrates 4 and 6. The inspection process is performed again on the thin glass substrates 4 and 6 on which the rework processing has been completed to determine whether or not the rework processing needs to be performed again.

In the meanwhile, in the liquid crystal panel 3 on which the rework processing needs not be performed in accordance with the determination made in the inspection process, the transparent protection plate 1 is already disposed opposite to the liquid crystal panel 3 via the transparent adhesive layer 9 from the front surface side of the liquid crystal panel 3 and the backlight 8 is already disposed opposite to the liquid crystal panel 3 from the back surface side of the liquid crystal panel 3, thus the liquid crystal display device according to the embodiment 2 is completed at the time of the determination that the rework processing needs not be performed.

Particularly, if the liquid crystal display device according to the embodiment 2 is a lateral electric field liquid crystal display device in the case of adopting the manufacturing method A, a lateral electric field liquid crystal display device having a high contrast characteristic can be obtained by adopting a manufacturing method described hereinafter. The manufacturing method is described using FIG. 9 appropriately. FIG. 9 is an explanation diagram for describing the method of adjusting the optical axis of the liquid crystal display device according to the embodiment 2.

In the manufacturing method A, the front surface polarization plate 2, the liquid crystal panel 3, and the back surface polarization plate 7 are disposed so that an angle between each polarization axis direction of the front surface polarization plate 2 and the back surface polarization plate 7 and a liquid crystal orientation direction of the liquid crystal panel 3 is set to an angle in which black luminance is minimum luminance.

Specifically, halfway through the manufacturing method A, in the process of placing the polarization plates 2 and 7 and the member fixed to the polarization plates 2 and 7 opposite to the thin glass substrates 4 and 6, which constitute the liquid crystal panel 3, these three constituent elements are rotationally operated so that angle directions of the three constituent elements change while monitoring transmitted light the state where these three constituent elements are disposed opposite to each other. Herein, the three constituent elements are the front surface polarization plate 2 and the transparent protection plate 1 fixed to the front surface polarization plate 2, the liquid crystal panel 3, and the back surface polarization plate 7 and the backlight 8 fixed to the back surface polarization plate 7.

Performed after determining the position of the three constituent elements in which the black luminance is minimum luminance is a process of fixing the polarization plates 2 and 7 and the member fixed to the polarization plates 2 and 7 to the thin glass substrates 4 and 6, which constitute the liquid crystal panel 3, to meet the determined positional relationship. The backlight 8, which is turned on, can also be used as a light source used in aligning the angle while monitoring the transmitted light as described above.

Applicable as the other method of simplifying the alignment process regarding the angle described above is to perform a cutout process while accurately measuring a polarization axis direction of a base material of a polarization plate in advance in a process of cutting out an outline of the polarization plate from the base material of the polarization plate performed by a manufacturer manufacturing the polarization plate so that an axis direction of the front surface polarization plate 2 and the back surface polarization plate 7 and an edge side direction of the front surface polarization plate 2 and the back surface polarization plate 7 are parallel to each other. In this manner, applicable is the process of obtaining the polarization plates in which the axis direction of the polarization plates and the edge side direction of the polarization plates arc parallel to each other, placing the pair of polarization plates opposite to each other to meet the positional relationship in which the black luminance is minimum luminance based on the edge side direction of the polarization plate using the obtained polarization plates, and fixing the pair of polarization plates to the thin glass substrates 4 and 6, which constitute the liquid crystal panel 3.

### (Effect)

The contrast characteristic can be optimized as the lateral electric field liquid crystal display device by manufacturing the liquid crystal display device using the manufacturing method A, that is to say, by placing the front surface polarization plate 2, the liquid crystal panel 3, and the back surface polarization plate 7 so that the angle between the polarization axis direction of the front surface polarization plate 2 and the back surface polarization plate 7 and the liquid crystal orientation direction of the liquid crystal panel 3 is set to the angle in which the black luminance is minimum luminance. Particularly, if the axis direction of the front surface polarization plate 2 and the back surface polarization plate 7 and the edge side direction of the front surface polarization plate 2 and the back surface polarization plate 7 are set to be parallel to each other, there is no need to adopt a complex manufacturing method of rotationally adjusting the polarization plates 2 and 7 and the member fixed to the polarization plates 2 and 7 to the liquid crystal panel 3. Accordingly, the contrast characteristic of the lateral electric field liquid crystal display device can be optimized at comparatively low cost.

### (The Manufacturing Method B)

Subsequently, the manufacturing method B of the liquid crystal display device according to the embodiment 2 is described using FIG. 10. The manufacturing method B basically corresponds to the manufacturing method of particularly the configuration in FIG. 7 in the embodiment 2, and as shown in FIG. 10, the polarization plates 2 and 7 are bonded to the liquid crystal panel 3. That is to say, the manufacturing method B is similar to the manufacturing method in the embodiment 1. In the manufacturing method B, firstly, after performing the process of forming the refraction index adjustment layers 13 and 14 and the frame-like bonding layers 13a and 14a on the surfaces of the polarization plates 2 and 7 disposed opposite to the thin glass substrates 4 and 6, the front surface polarization plate 2 and the back surface polarization plate 7 are bonded to the surfaces of the thin glass substrates 4 and 6 of the liquid crystal panel 3 from the front surface side and the back surface side, respectively. In this state, as described in the configuration in FIG. 7, the polarization plates 2 and 7 and the thin glass substrates 4 and 6 are fixed to each other at the peripheral portions with the small temporal fixation degree, respectively.

Subsequently, in the manner similar to the manufacturing method in the embodiment 1, the inspection process is performed to appropriately confirm whether or not a foreign material or the like enters between the front surface polarization plate 2 and the thin glass substrate 4 and between the back surface polarization plate 7 and the thin glass substrate 6 in the state where the polarization plates 2 and 7 are disposed opposite to the thin glass substrates 4 and 6, respectively, and confirm whether or not the rework processing needs to be perforated on the polarization plates 2 and 7 disposed opposite to the thin glass substrates 4 and 6.

The rework processing is performed on the liquid crystal panel 3 on which the rework processing needs to be performed in accordance with the determination made in the inspection process. Since the front surface polarization plate 2 and the back surface polarization plate 7 are temporarily fixed to the thin glass substrates 4 and 6 at the peripheral portions, respectively, the rework processing can be comparatively easily performed without damaging the thin glass substrates 4 and 6. The inspection process is performed again on the thin glass substrates 4 and 6 on which the rework processing has been completed to determine whether or not the rework processing needs to be performed again.

In the meanwhile, in the liquid crystal panel 3 on which the rework processing needs not be performed in accordance with the determination made in the inspection process, the transparent protection plate 1 is disposed opposite to the liquid crystal panel 3 via the transparent adhesive layer 9 from the front surface side of the liquid crystal panel 3 and the backlight 8 is disposed opposite to the liquid crystal panel 3 via the third bonding layer 12 from the back surface side of the liquid crystal panel 3, thus the liquid crystal display device according to the embodiment 2 is completed. The transparent protection plate 1 is fixed to the front surface side of the liquid crystal panel 3 with the transparent adhesive layer 9 therebetween, and the backlight 8 is fixed to the back surface side of the liquid crystal panel 3 with the third bonding layer 12 therebetween. Herein, the third bonding layer 12 is provided to have a frame-like shape to correspond to a frame-like surface of the backlight 8. It is preferable to appropriately fix the transparent protection plate 1 and the backlight 8 to each other.

### (Effect)

Also in the liquid crystal display device according to the embodiment 2 having the above configuration and manufactured through the manufacturing method described above, the polarization plates 2 and 7 can be easily separated in the state of constituting the liquid crystal panel 3, thus the rework processing can be performed on the polarization plates 2 and 7 even though the liquid crystal panel 3 has the thin glass substrates 4 and 6.

Furthermore, if the liquid crystal display device is manufactured using he manufacturing method B, the polarization plates 2 and 7 are fixed to the liquid crystal panel 3, thus the processing subsequent to the fixing process of the polarization plates 2 and 7 can be achieved by a conventional manufacturing process, and an inspection can he performed in the state where the polarization plates 2 and 7 are fixed. Inconvenience in display such as a surface reflectivity does not occur. Furthermore, the polarization plates 2 and 7 are firmly bonded and fixed to the transparent protection plate 1 and the backlight 8 in the state where the liquid crystal display device is completed in any of the embodiments of the embodiment 2. Thus, a misalignment caused by vibration and the other factor does not occur, but both the effect of obtaining the high reliability and the effect of reducing the cost achieved by performing the rework processing can be obtained.

### Modification Example of Embodiment 2

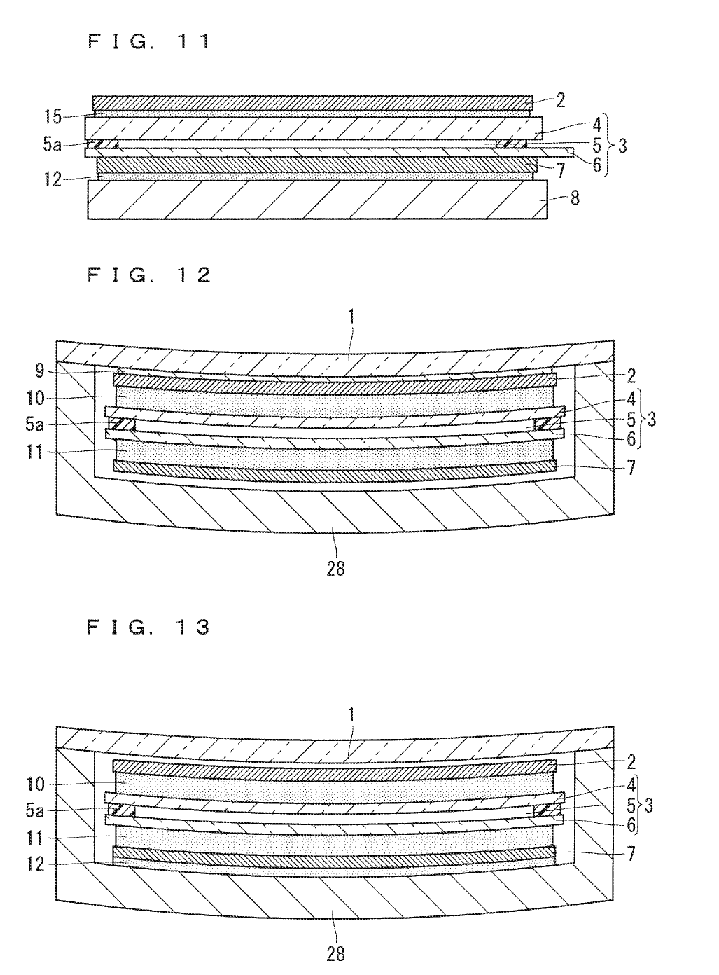

Described in the embodiment 2 is the liquid crystal display device applied to the configuration that the transparent protection plate 1 is disposed on the front surface side of the liquid crystal panel 3 via the transparent adhesive layer 9, however, the liquid crystal display device may also be applied to the configuration that the transparent protection plate 1 is not particularly disposed by reason that, if a thin glass substrate having a general thickness of approximately 0.3 mm is used as the thin glass substrate 6 on the back surface side and a glass substrate having a general thickness of 0.5 mm or more is used as the thin glass substrate 4 on the front surface side as shown in FIG. 11, for example, there is no problem in the rework processing performed on the polarization plate 2 on the front surface side.

That is to say, in the configuration of the modification example in the embodiment 2 shown in FIG. 11, if the front surface polarization plate 2 is the glass substrate having the general thickness of 0.5 mm or more, the front surface polarization plate 2 is fixed using a bonding agent having adhesion strength capable of performing the rework processing without breaking the glass substrate.

In the meanwhile, the back surface polarization plate 7 is fixed to the backlight 8 with the third bonding layer 12 therebetween in the manner similar to the case of the embodiment 2. The back surface polarization plate 7 may have the configuration of being disposed opposite to the thin glass substrate 6 in a state where the back surface polarization plate 7 and the back surface side of the thin glass substrate 6 are in close contact with each other with no constituent element therebetween as shown in FIG. 11, or may also have the configuration of being disposed opposite to the thin glass substrate 6 with the refraction index adjustment layer 14 therebetween in the manner similar to the configuration shown in FIG. 7.

### (Effect)

As described above, also in the liquid crystal display device according to the modification example in the embodiment 2, with regard to the back surface polarization plate disposed opposite to the thin glass substrate, the polarization plates 2 and 7 can be easily separated in the state of constituting the liquid crystal panel 3, thus the rework processing can be performed on the polarization plate even though the liquid crystal panel 3 is the liquid crystal panel using the thin glass substrate, and if the configuration of placing the polarization plate via the refraction index adjustment layers 13 and 14 is adopted, inconvenience in display such as a surface reflectivity does not occur.

Furthermore, the front surface polarization plate 2 and the back surface polarization plate 7 are firmly fixed to the glass substrate 4 and the backlight 8, respectively, in the state where the liquid crystal display device is completed, thus the misalignment caused by the vibration and the other factor does not occur. Thus, both the effect of obtaining the high reliability and the effect of reducing the cost achieved by performing the rework processing can be obtained.

### Embodiment 3

Next, a liquid crystal display device according to the embodiment 3 is described. FIG. 12 is a cross sectional view of the liquid crystal display device according to the embodiment 3. FIG. 13 is a cross sectional view of another example of the liquid crystal display device according to the embodiment 3. In the embodiment 3, the same reference numerals as those described in the embodiments 1 and 2 will be assigned to the same constituent element and the description thereof will be omitted.

As shown in FIG. 12, an extremely thin glass substrate which can be curved and is processed to have a thickness of approximately 0.15 mm as an example of the thin glass substrates used for a curved type liquid crystal display device is adopted to a configuration of the liquid crystal display device according to the embodiment 3. The liquid crystal display device includes the liquid crystal panel 3 in which two extremely thin glass substrates 4 and 6 are disposed opposite to each other via the liquid crystal layer 5. Furthermore, the polarization plates 2 and 7 are disposed on the two extremely thin glass substrates 4 and 6 which constitute the liquid crystal panel 3, via the first bonding layer 10 and the second bonding layer 11, respectively, and the extremely thin glass substrates 4 and 6 are temporarily fixed by the first bonding layer 10 and the second bonding layer 11.

As shown in FIG. 12, the liquid crystal display device according to the embodiment 3 is common to the liquid crystal display device according to the embodiment 1 particularly in that the transparent protection plate 1 provided for purpose of protecting the liquid crystal panel 3 is disposed on the front surface side of the liquid crystal panel 3 via the transparent adhesive layer 9. However, the liquid crystal display device according to the embodiment 3 has two features, One of the features is that the transparent protection plate 1 has a curved shape. The other one of the feature is that the front surface polarization plate 2 is fixed to a curved surface which is a surface of a curved shape of the transparent protection plate 1 with the transparent adhesive layer 9 therebetween and the front surface polarization plate 2 is temporarily fixed to the liquid crystal panel 3 with the first bonding layer 10 therebetween, thus the liquid crystal panel 3 is fixed to the transparent protection plate 1 with the transparent adhesive layer 9 therebetween while being curved to have a shape following the curved surface of the transparent protection plate 1.

In the embodiment 3, the liquid crystal display device includes a backlight 28 instead of the backlight 8. The backlight 28 has a case-like shape whose front side is opened so to be able to house the front surface polarization plate 2, the liquid crystal panel 3, and the back surface polarization plate 7. The backlight 28 also has a curved shape. More specifically, an upper end of a peripheral wall portion of the backlight 28 is inclined so that a height position inside the upper end is lower than that outside the upper end, and a bottom portion of the backlight 28 has a curved shape. Furthermore, the transparent protection plate 1 having the curved shape is fixed to the backlight 28 having the curved shape.

In the configuration shown in FIG. 12, the liquid crystal panel 3 is fixed to the transparent protection plate 1 having the curved shape to follow the curved surface thereof, thus the liquid crystal panel 3 is deformed to have the curved shape. Since the backlight 28 also has the curved shape, also applicable is a configuration that the liquid crystal panel 3 is fixed to and follow the curved surface of the backlight 28 having the curved shape with the third bonding layer 12 therebetween, thereby being deformed to have the curved shape as shown in FIG. 13 in the manner similar to the case where the liquid crystal panel 3 is fixed to the side of the backlight 8 in the embodiment 2. Herein, the curved surface of the transparent protection plate 1 is a rear surface of the transparent protection plate 1. The curved surface of the backlight 28 is a front surface of the bottom portion of the backlight 28.

Also applicable is a configuration that the configurations in FIG. 12 and FIG. 13 are combined so that the front surface side of the liquid crystal panel 3 is fixed to the curved surface of the transparent protection plate 1 having the curved shape with the transparent adhesive layer 9 therebetween, and the back surface side of the liquid crystal panel 3 is fixed to the curved surface of the backlight 28 having the curved shape with the third bonding layer 12 therebetween. In this case, the curved surface of the backlight 28 has the same shape, in other words, the same curvature, as the curved surface of the transparent protection plate 1. Accordingly, a stress on the liquid crystal panel 3 and a gap are uniformed, and an occurrence of defect is reduced.

However, in the case where the front surface side and the back surface side of the liquid crystal panel 3 are fixed to each of the curved surfaces, if the curvatures of the curved surfaces do not coincide with each other, it is concerned that the stress and the gap are ununiformed, thereby causing the defect.

In the meanwhile, if a configuration of fixing the liquid crystal panel 3 to one of the transparent protection plate 1 and the backlight 28 each having the curved shape is applied as the configuration shown in FIG. 12 and FIG. 13, the curvature of the liquid crystal panel 3 can be adjusted to the curvature of one of them. Accordingly, even if the curvatures of the transparent protection plate 1 and the backlight 28 do not coincide with each other, for example, the curve of the liquid crystal panel 3 can be determined in accordance with the curvature of the curved surface of one of them. Since the defect does not occur due to the unevenness of the stress and the gap, such a configuration is more preferable.

### (Effect)

As described above, in the liquid crystal display device according to the embodiment 3, the rework processing can be performed on the polarization plates 2 and 7 even though the liquid crystal panel 3 has the extremely thin glass substrates 4 and 6 whose thickness are remarkably reduced to approximately 0.2 mm or less to curve the liquid crystal panel 3 in the temporal fixation state. Since the front surface polarization plate 2 and the back surface polarization plate 7 are fixed in the state where the liquid crystal panel 3 is configured in a conventional manner, a process subsequent to the fixing process of the front surface polarization plate 2 and the back surface polarization plate 7 can be achieved by a conventional manufacturing process. Inconvenience in display such as a surface reflectivity does not occur.

Furthermore, the front surface polarization plate 2 and the back surface polarization plate 7 are firmly fixed to the extremely thin glass substrates 4 and 6, respectively, in the state where the liquid crystal display device is completed, and the liquid crystal panel 3 is firmly fixed to any of the transparent protection plate 1 and the backlight 28, thus the misalignment caused by the vibration and the other factor does not occur, but both the effect of obtaining the high reliability and the effect of reducing the cost achieved by performing the rework processing can be obtained.

### Embodiment 4

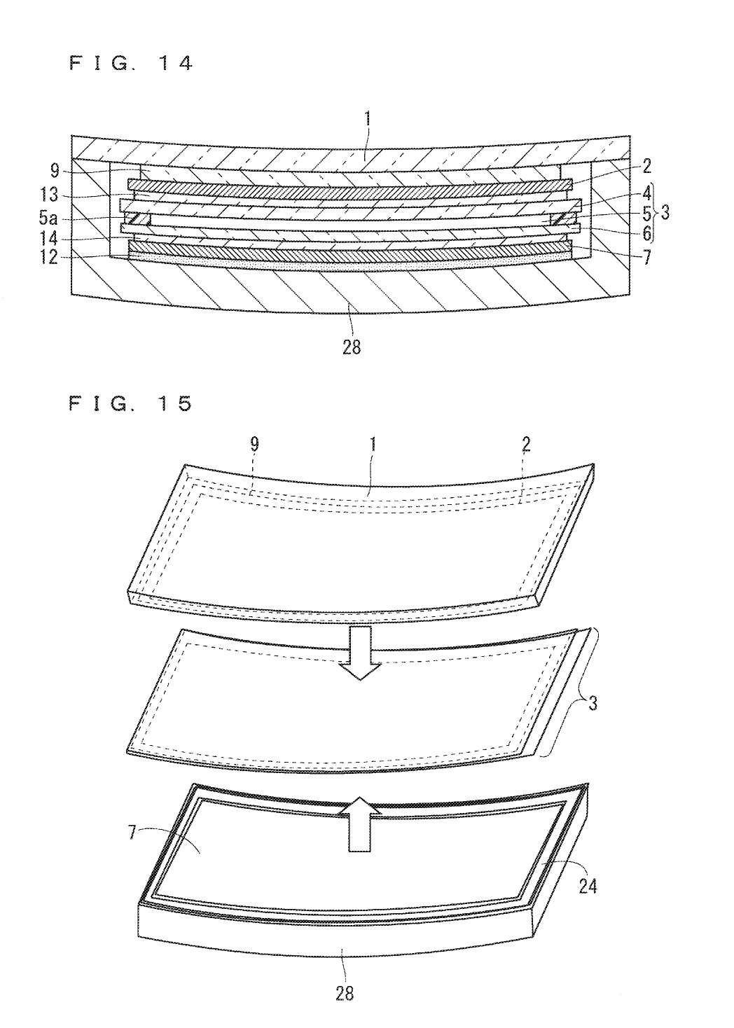

Next, a liquid crystal display device according to the embodiment 4 is described. FIG. 14 is a cross sectional view of the liquid crystal display device according to the embodiment 4. FIG. 15 is an explanation diagram for describing a retention form of each of the polarization plates 2 and 7 of the liquid crystal display device according to the embodiment 4. In the embodiment 4, the same reference numerals as those described in the embodiments 1 to 3 will be assigned to the same constituent element and the description thereof will be omitted.

As shown in FIG. 14, an extremely thin glass substrate which can be curved and is processed to have a thickness of approximately 0.15 mm as an example of the extremely thin glass substrate used for a curved type liquid crystal display device is adopted to a configuration of the liquid crystal display device according to the embodiment 4.

Furthermore, the liquid crystal display device according to the embodiment 4 is common in that the front surface polarization plate 2 and the back surface polarization plate 7 are disposed opposite to the two extremely thin glass substrates 4 and 6 constituting the liquid crystal panel 3. However, the liquid crystal display device according to the embodiment 4 is different in that with regard to a constituent element to which the polarization plates 2 and 7 are fixed, the front surface polarization plate 2 is fixed to the transparent protection plate 1 having the curved shape disposed opposite to the front surface side of the liquid crystal panel 3 with the transparent adhesive layer 9 therebetween, and the back surface polarization plate 7 is fixed to the backlight 28 having the curved shape disposed opposite to the back surface side of the liquid crystal panel 3 with the third bonding layer 12 therebetween.

In the meanwhile, as a configuration between the front surface polarization plate 2 and the back surface polarization plate 7 and the two extremely thin glass substrates 4 and 6, which constitute the liquid crystal panel 3, the front surface polarization plate 2 and the back surface polarization plate 7 are disposed opposite to the extremely thin glass substrates 4 and 6 with the refraction index adjustment layers 13 and 14 therebetween as shown in FIG. 14. Also applicable is a configuration that the polarization plates 2 and 7 are disposed opposite to the extremely thin glass substrates 4 and 6 to be in close contact with the extremely thin glass substrates 4 and 6, respectively, with no constituent element therebetween as shown in FIG. 6.

The retention form of each of the polarization plates 2 and 7 is described using FIG. 15. As shown in FIG. 15, the backlight 28 having the curved shape has the curved surface which has the same curvature as the curved surface of the transparent protection plate 1 having the curved shape. The curved surface included in the backlight 28 is provided to have a frame-like shape around an opening portion substantially having a rectangular shape as shown in FIG. 15. The back surface polarization plate 7 is fixed to the curved surface of the backlight 28 provided to have the frame-like shape with the frame-like third bonding layer 12 therebetween.

The liquid crystal panel 3 is sandwiched between the curved surface of the front surface polarization plate 2, which is fixed to the transparent protection plate 1 having the curved shape, formed on a side where the liquid crystal panel 3 is disposed and the curved surface of the back surface polarization plate 7, which is fixed to the backlight 28 having the curved shape, formed on a side where the liquid crystal panel 3 is disposed, thereby being deformed to have the curved shape and retained. Particularly in the embodiment 4, the liquid crystal panel 3 is sandwiched by the front surface polarization plate 2 and the back surface polarization plate 7 with the refraction index adjustment layers 13 and 14 therebetween, thereby being retained.

### (Effect)

As described above, in the liquid crystal display device according to the embodiment 4, the rework processing can be performed on the polarization plates 2 and 7 even though the liquid crystal panel has the extremely thin glass substrates 4 and 6 whose thickness are remarkably reduced to approximately 0.2 mm or less to curve the liquid crystal panel 3 in the temporal fixation state in the manner similar to the case of the embodiment 2. If the configuration of placing the liquid crystal panel 3 via the refraction index adjustment layers 13 and 14 is applied, inconvenience in display such as a surface reflectivity does not occur.

Furthermore, the polarization plates 2 and 7 are firmly fixed to the transparent protection plate 1 and the backlight 28 each having the curved shape, respectively, in the state where the liquid crystal display device is completed, thus the misalignment caused by the vibration and the other factor does not occur, but both the effect of obtaining the high reliability and the effect of reducing the cost achieved by performing the rework processing can be obtained.

Furthermore, since the extremely thin glass substrates 4 and 6 and the polarization plates 2 and 7 of the liquid crystal panel 3 are curved without being tightly bonded to each other, it is possible to suppress a display unevenness caused by a stress unevenness occurring in a structure that a polarization plate fixed to a flat-plate liquid crystal panel is curved as is the case of the conventional curved type liquid crystal display device.

The curved surface of the backlight 28 has the same curvature as the curved surface of the transparent protection plate 1, the backlight 28 has the case-like shape whose front side is opened so to be able to house the front surface polarization plate 2, the liquid crystal panel 3, and the back surface polarization plate 7, and the back surface polarization plate 7 is fixed to the curved surface of the backlight 28 with the frame-like third bonding layer 12. Accordingly, the stress on the liquid crystal panel 3 and the gap are uniformed, and the occurrence of defect is reduced.

The transparent protection plate 1 is fixed to the front surface polarization plate 2 with the transparent adhesive layer 9 therebetween in the state where the front surface polarization plate 2, the liquid crystal panel 3, and the back surface polarization plate 7 are housed inside the backlight 28, and the back surface polarization plate 7 is fixed to the curved surface of the backlight 28 with the third bonding layer therebetween, thus the liquid crystal panel 3 is retained to have the curved shape. Accordingly, the liquid crystal panel 3 having the desired curvature can be obtained by designing the curved surfaces provided in the transparent protection plate 1 and the backlight 28 to have the desired curvatures.

### (Definition of the Thin Glass Substrate and the Extremely Thin Glass Substrate)

In the present specification, the range of the thickness of the glass substrate which is considered as the thin glass substrate is typically approximately 0.3 mm in the embodiments 1 and 2 and the modification examples thereof. The remarkable effect can be obtained if the thickness of the thin glass substrate is equal to or less than 0.3 mm compared with the case where the glass substrate having the thickness making the rework processing difficult to perform, that is to say, having the general thickness of approximately 0.5 mm is used in a case of using the polarization plate having the general adhesion property.

Furthermore, the range of the thickness of the glass substrate which is considered as the extremely thin glass substrate is typically approximately 0.15 mm in the embodiments 3 and 4, however, the range of the thickness of the extremely thin glass substrate which can be preferably used in the curved type liquid crystal display device is 0.2 mm or less. In this case, the significant effect can be obtained compared with the liquid crystal display device in which the glass substrate with the thickness of approximately 0.3 mm, which is the thin glass substrate used in the general liquid crystal display device, is used. A lower limit of the range of the extremely thin glass substrate is interpreted as a range of 0.01 mm or more, which is a lower limit of the thickness of the glass substrate used in the liquid crystal display device.

Accordingly, the extremely thin glass substrate used in the present specification is defined as a glass substrate having a thickness ranging from 0.01 mm to 0.2 mm, and the description is based on this definition. As described above, the extremely thin glass substrate is not limited to that having the thickness of approximately 0.15 mm illustrated in the embodiments 3 and 4, but the effect similar to the case of the embodiments 3 and 4 can be obtained even when the extremely thin glass substrate having the thickness ranging from 0.01 mm to 0.2 mm is used.

According to the present invention, the above embodiments can be arbitrarily combined, or each embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device, comprising:
a liquid crystal panel having a pair of glass substrates being disposed opposite to each other via a liquid crystal layer;
a backlight being disposed on a back surface side of the liquid crystal panel;
a front surface polarization plate being disposed on a front surface of the liquid crystal panel via a first bonding layer; and
a back surface polarization plate being disposed on a back surface of the liquid crystal panel via a second bonding layer between the liquid crystal panel and the backlight; wherein
each of the first bonding layer and the second bonding layer is any of an uncured bonding layer having a property that an adhesion property capable of fixing the front surface polarization plate and the back surface polarization plate to the liquid crystal panel can be obtained through curing processing and a semi-cured bonding layer having a property of being softened through softening processing.

2. The liquid crystal display device according to claim 1, wherein
the uncured bonding layer has a property that the uncured bonding layer is cured through one of thermal curing processing, photo-curing processing, and drying processing and an adhesion property capable of fixing the front surface polarization plate and the back surface polarization plate to the liquid crystal panel is thereby obtained, and
the semi-cured bonding layer is made up of one of a hot-melt resin and a light-softened resin.

3. A liquid crystal display device, comprising:
a liquid crystal panel having a pair of glass substrates being disposed opposite to each other via a liquid crystal layer;
a backlight being disposed on a back surface side of the liquid crystal panel;
a front surface polarization plate being disposed on a front surface of the liquid crystal panel; and
a back surface polarization plate being disposed between the liquid crystal panel and the backlight; wherein
the back surface polarization plate fixed to the backlight.

4. The liquid crystal display device according to claim 3, further comprising
refraction index adjustment layers being disposed between the front surface polarization plate and the liquid crystal panel and between the liquid crystal panel and the back surface polarization plate.

5. The liquid crystal display device according to claim 1, further comprising
a transparent protection plate being fixed to a front surface of the front surface polarization plate via a transparent adhesive layer.

6. The liquid crystal display device according to claim 3, further comprising
a transparent protection plate being fixed to a front surface of the front surface polarization plate via a transparent adhesive layer.

7. The liquid crystal display device according to claim 5, wherein
each of the pair of the glass substrates is an extremely thin glass substrate which can be curved, and
each of the transparent protection plate and the backlight has a curved surface having a curved shape.

8. The liquid crystal display device according to claim 6, wherein
each of the pair of the glass substrates is an extremely thin glass substrate which can be curved, and
each of the transparent protection plate and the backlight has a curved surface having a curved shape.

9. The liquid crystal display device according to claim 7, wherein
the curved surface of the backlight has a curvature identical with a curvature of the curved surface of the transparent protection plate,
the backlight has a case-like shape whose front side is opened so to be able to house the front surface polarization plate, the liquid crystal panel, and the back surface polarization plate, and
the back surface polarization plate is fixed to the curved surface of the backlight via a third bonding layer having a frame-like shape.

10. The liquid crystal display device according to claim 8, wherein
the curved surface of the backlight has a curvature identical with a curvature of the curved surface of the transparent protection plate,
the backlight has a case-like shape whose front side is opened so to be able to house the front surface polarization plate, the liquid crystal panel, and the hack surface polarization plate, and
the back surface polarization plate is fixed to the curved surface of the backlight via a third bonding layer having a frame-like shape.

11. The liquid crystal display device according to claim 9, wherein
the transparent protection plate is fixed to the front surface polarization plate via the transparent adhesive layer in a state where the front surface polarization plate, the liquid crystal panel, and the back surface polarization plate are housed inside the backlight, and the back surface polarization plate is fixed to the curved surface of the backlight via the third bonding layer, thus the liquid crystal panel is retained to have a curved shape.

12. The liquid crystal display device according to claim 10, wherein
the transparent protection plate is fixed to the front surface polarization plate via the transparent adhesive layer in a state where the front surface polarization plate, the liquid crystal panel, and the back surface polarization plate are housed inside the backlight, and the back surface polarization plate is fixed to the curved surface of the backlight via the third bonding layer, thus the liquid crystal panel is retained to have a curved shape.

13. The liquid crystal display device according to claim 3, wherein
the liquid crystal display device is a lateral electric field liquid crystal panel, and
an angle between a polarization axis direction of the front surface polarization plate and the back surface polarization plate and a liquid crystal orientation direction of the liquid crystal panel is an angle in which black luminance is set to minimum luminance.

14. The liquid crystal display device according to claim 13, wherein
the polarization axis direction of the front surface polarization plate and the back surface polarization plate and an edge side direction of the front surface polarization plate and the back surface polarization plate are parallel to each other.

15. A manufacturing method of manufacturing the liquid crystal display device according to claim 5, comprising:
(a) fixing the front surface polarization, plate and the back surface polarization plate to the transparent protection plate and the backlight, respectively; and
(b) placing the front surface polarization plate being fixed to the transparent protection plate and the back surface polarization plate being fixed to the backlight opposite to the liquid crystal panel.

16. A manufacturing method of manufacturing the liquid crystal display device according to claim 6, comprising:
(a) fixing the front surface polarization plate and the back surface polarization plate to the transparent protection plate and the backlight, respectively; and
(b) placing the front surface polarization plate being fixed to the transparent protection plate and the back surface polarization plate being fixed to the backlight opposite to the liquid crystal panel.

17. A manufacturing method of manufacturing the liquid crystal display device according to claim 5, comprising:
(c) temporarily and detachably fixing the front surface polarization plate and the back surface polarization plate to the liquid crystal panel; and
(d) fixing the liquid crystal panel, to which the front surface polarization plate and the back surface polarization plate are temporarily fixed, to the backlight and the transparent protection plate.

18. A manufacturing method of manufacturing the liquid crystal display device according to claim 6, comprising;
(c) temporarily and detachably fixing the front surface polarization plate and the back surface polarization plate to the liquid crystal panel; and
(d) fixing the liquid crystal panel, to which the front surface polarization plate and the hack surface polarization plate are temporarily fixed, to the backlight and the transparent protection plate.

19. A manufacturing method of manufacturing the liquid crystal display device according to claim 1, comprising:
(e) applying an uncured bonding agent having a property that the uncured bonding agent does not have an adhesion property capable of fixing the front surface polarization plate and the back surface polarization plate to the liquid crystal panel at least at a time of being applied but obtains the adhesion property capable of fixing the front surface polarization plate and the back surface polarization plate to the liquid crystal panel through curing processing, thereby temporarily and detachably fixing the front surface polarization plate and the back surface polarization plate to the liquid crystal panel;
(f) confirming whether or not rework processing needs to be performed on the front surface polarization plate and the back surface polarization plate; and
(g) curing the uncured bonding agent at least before a completion of the liquid crystal display device.

20. A manufacturing method of manufacturing the liquid crystal display device according to claim 1, comprising:
(h) applying a semi-cured bonding agent having a property of being softened through softening processing, thereby temporarily and detachably fixing the front surface polarization plate and the back surface polarization plate to the liquid crystal panel;
(i) confirming whether or not rework processing needs to be performed on the front surface polarization plate and the back surface polarization plate; and
(j) softening the semi-cured bonding agent if rework processing needs to be performed.
